(19) United States
(12) Patent Application Publication
(10) Pub. No.: US 2009/0015814 A1
(43) Pub. Date: Jan. 15, 2009

(54) DETECTOR FOR REGISTERING A LIGHT INTENSITY, AND ILLUMINATION SYSTEM EQUIPPED WITH THE DETECTOR

(75) Inventor: Ulrich Mueller, Oberkochen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/169,466

(22) Filed: Jul. 8, 2008

(30) Foreign Application Priority Data
Jul. 11, 2007 (DE) 10 2007 032 334.6

(51) Int. Cl. G03B 27/74; G01T 1/20

(52) U.S. Cl. 355/68; 250/370.11

(57) ABSTRACT

The invention concerns a device for the detection of radiation with a wavelength λ<100 nm, preferably EUV radiation in a range of wavelengths 5 nm<λ_{EUV}<30 nm, in an illumination system.

The device encompasses:
a conversion element (4) which contains a scintillator material (22) which converts radiation with wavelengths <100 nm falling on the conversion element, by interacting with said radiation with wavelengths <100 nm, into a radiation with a wavelength λ_{fluorescent}>100 nm, and
a detection element (5) for the detection of the radiation with a wavelength λ_{fluorescent}>100 nm which is received by the light-conducting element.

### FIELD OF THE INVENTION

The invention relates to a device for the detection of radiation with wavelengths shorter than 250 nm, preferably shorter than 160 nm, particularly shorter than 100 nm, with special preference for a range of wavelengths of 5 nm<λ_{EUV}<30 nm, an illumination system equipped with such a detector, a method for the detection of radiation with wavelengths shorter than 160 nm, preferably shorter than 100 nm, in particular EUV radiation in a range of wavelengths of 5 nm<λ_{EUV}<30 nm, as well as a method of setting an essentially invariant light intensity in a field plane of a microlithography projection exposure apparatus equipped with a detector.

### STATE OF THE ART

In order to be able to further reduce the structure widths of electronic components, specifically into the sub-micron range, it is necessary to resort to shorter wavelengths of the light used for the microlithography process. It is conceivable to use wavelengths shorter than 100 nm, an example of which is the lithography with soft X-rays, the so-called EUV (extreme ultraviolet) lithography. The latter is one of the most promising lithography techniques of the future. Wavelengths that are currently being discussed for EUV lithography are in the range from 11 nm to 14 nm, in particular 13.5 nm. The image quality achieved with EUV lithography is determined on the one hand by the projection objective and on the other hand by the illumination system. The illumination system should deliver the most uniform illumination possible in a field plane where a mask carrying a structure, the so-called reticle, is arranged. The projection objective projects an image of the field plane into an image plane, the so-called wafer plane in which a light-sensitive object is arranged. Projection exposure apparatus for EUV lithography are generally implemented with reflective optical elements. The shape of the field in the field plane of a projection exposure apparatus can for example be rectangular or, for example in the realm of EUV lithography, a ring field with a high aspect ratio. With the scanning lithography technique, the dimension of the illuminated field in the field plane is larger in the direction perpendicular to the scan than the dimension in the direction of the scan. In the case of a ring field, the dimension of the field is generally characterized by the width and the arc length. The width of the field is in this case the dimension in the scanning direction. In an example of an embodiment, the width W of the ring field is more than 1 mm, preferably more than 2 mm, and the arc length is more than 22 mm, preferably more than 26 mm. The projection exposure apparatus are normally operated in scanning mode. Concerning the subject of EUV projection exposure apparatus, the reader is referred to the following literature:

US 2005/0088760A

U.S. Pat. No. 6,438,199B

U.S. Pat. No. 6,859,328B

In a microlithography process, in order to project the finest structures possible from the reticle which is arranged in the field plane onto a substrate which carries a light-sensitive coating, specifically a photoresist, for example onto a wafer, it is necessary to very accurately control the radiation dose which is received by the light-sensitive coating; this is particularly necessary if the light-sensitive coating has a non-linear sensitivity.

As a feature that is known from refractive projection exposure systems, in particular for wavelengths around 248 nm and 193 nm, there are photodiodes arranged in the illumination system or near the reticle plane, which produce an electrical signal representative of the radiation intensity in the plane in which the exposure object is arranged. The electrical signal registered by the photodiode serves as the current actual value of a control variable in a regulation loop. By comparing the actual value to a target value, a difference signal is obtained which can be used to adjust the intensity of the light source, for example by controlling the pulse rate of the light source. This makes it possible to ensure a constant radiation dose over time. As an alternative or in addition to controlling the light source, it is possible to control the scan velocity of the exposure object in the image plane. Refractive systems in which the dose is controlled in this manner have been described in the following references:

U.S. Pat. No. 6,211,947B

U.S. Pat. No. 6,603,533B

U.S. Pat. No. 6,842,500B

US 2005/0057739A1

The sensors which are known from state-of-the-art refractive systems are only conditionally usable for measurements in the EUV range of wavelengths with 5≦λ_{EUV}≦30 nm. Although sensors such as photodiodes which directly receive the EUV rays are known to be used for the measurement of EUV radiation, as described in the references

U.S. Pat. No. 6,855,932B,

US 2003/0146391A,

a direct exposure of photodiodes to EUV light has disadvantages. For example, the photo-electrons of the photodiode which are released from the irradiated surface lead to the buildup of electrostatic charges and thus to a change of the internal space-charge field. As the space charge field is changed by the buildup of electrostatic charges during operation of the microlithography projection exposure apparatus under vacuum, this has the consequence that the basically good linearity of the photodiode deteriorates. Photodiodes have the further disadvantage that the sensitive area is much smaller than the geometric dimensions of the photodiode. If the EUV light falls directly on the sensor, it is possible that the measurement signal is falsified by the external photoelectric effect or by parasitic plasma discharges. The use of photodiodes in the vacuum area of a microlithography projection exposure apparatus poses a further significant problem, as the EUV radiation falling on the photodiode leads to a strong heating of the photodiode. However, cooling can be provided in a vacuum only to a limited extent through mechanical contact with adjacent parts such as for example the frame. Furthermore, photodiodes as electronic components are susceptible to damage from electrostatic discharges and thermal overload.

### SUMMARY OF THE INVENTION

It is therefore the object of the invention to propose a sensor for the measurement of radiation in an illumination system, in particular for wavelengths shorter than 100 nm, which overcomes the disadvantages of the state of the art.

According to the invention, this is accomplished with a device for the detection of radiation, in particular with wavelengths shorter than 100 nm, preferably radiation in a range of wavelengths of 5 nm<λ_{EUV}<30 nm, wherein the detection device includes a conversion element that contains a scintillator material. Through interaction with the scintillator material the conversion element converts the incident radiation into radiation with a wavelength that is larger than the wavelength of the incident radiation, particularly into radiation with wavelengths larger than 100 nm, preferably in the visible or infrared range of wavelengths.

The radiation is received by a detection element. The detection element can for example be a VIS photodiode.

In a preferred embodiment, the radiation with a wavelength larger than 100 nm is received by a light-conducting element. The light conducting element directs the received radiation to a detector element for the detection of the radiation with a wavelength λ>100 nm.

However, if the device according to the invention is used for the detection of radiation with a wavelength shorter than 250 nm, this radiation is converted by the conversion element into a radiation with a wavelength longer than 250 nm.

The device according to the invention is distinguished in particular by its very good mechanical stability and the fact that it consists of very few components. Furthermore, it involves no direct irradiation of the detection element, in particular the photodiode, with light of a short wavelength, for example EUV light. As a result of this, the operating life of the detection element can be lengthened considerably. Added to this is the advantage that only the conversion element and the light-conducting element, which are both passive components, are arranged in the space traversed by the radiation that is being used, for example by EUV light. Due to the light-conducting element, the detection element, being an active electronic component, can be placed outside of the vacuum chamber in which the illumination system is arranged. With particular preference, the following are used as scintillator materials: quartz glass, YAG- or YAP-crystals doped with cerium, europium-doped calcium fluoride, barium fluoride, zinc selenide doped with tellurium, CdWO₄, and cesium iodide doped with thallium. The scintillator materials have the effect that the EUV radiation produces light flashes, so-called scintillations. In the present context, the terms scintillation and luminescence are used synonymously. Scintillation and luminescence relate to the absorption of light and the subsequent emission of light, wherein the emitted light has a wavelength that is shifted towards the long-wave part of the spectrum. Scintillator materials are also often called phosphors. As indicated by the preceding examples, the selection of scintillator materials is in essence restricted to inorganic materials that have the requisite properties to ensure that the conversion element is compatible with an ultra-high-vacuum environment. If organic elements were used for the conversion element, this would generally lead to contamination of the ultra-high vacuum by hydrocarbons.

Sensors that include scintillation materials are disclosed for example in U.S. Pat. No. 6,551,231 or in U.S. Pat. No. 5,640,017.

The known state of the art of investigating UV- and X-rays also includes systems with fluorescent materials which serve to convert rays of a short wave length into long-wave radiation. In this regard, the reader is referred to U.S. Pat. No. 5,498,923.

As a light-conducting element, a light-conducting fiber can be used, preferably a glass- or quartz fiber whose light-conducting function is based on a total reflection. To achieve this property, the fiber has a larger refractive index in its core portion than in its circumferential surface layer (also referred to as the cladding of the optical fiber). As an alternative to the light conductors, it is possible to use metallic reflectors as light-conducting elements, for example in the form of a tube that is polished on the inside, or a glass rod with a vapor-deposited reflective coating. It is also conceivable to use a mirror which receives the fluorescent or luminescent light generated through the scintillation and directs the light to the detection element. Of course, a combination of a mirror with a light-conducting fiber is likewise conceivable.

The conversion element which includes the scintillator material is preferably configured in such a way that the fluorescent light, or luminescent light, generated by the scintillator is coupled as effectively as possible into the light-conducting element, in this case preferably into the light conductor. As the penetration depth of EUV radiation into the scintillator material is only a few nanometers, it is advantageously envisioned that the conversion element has as scintillator material a scintillator layer which allows the incident EUV radiation to be absorbed over a surface area. The layer thickness of the scintillator layer is preferably less than 1 mm, with higher preference less than 0.1 mm, with particular preference less than 0.01 mm, and with special preference less than 0.001 mm.

The scintillator layer can be applied to the light conductor fiber at totally different locations. For example, in a first embodiment of the invention, the scintillator layer can be placed on the end surface of the light-conducting fiber. If the light-conducting fiber consists of a cladding and a core, the scintillator layer can also be applied in the area of the cladding, or a part of the cladding itself can function as scintillator layer. As an alternative, the light-conducting fiber can also be given an obliquely angled end surface, and the scintillator layer can be applied to the oblique surface.

The different arrangements of the scintillator layer on the light-conducting fiber have the advantage that the scintillator layer can be oriented in accordance with the available space and the emission properties of the radiation that is to be detected. It thus becomes unnecessary to bend the light-conducting fiber in order to be able to detect light from a specific spatial sector. Rather, the light-conducting fiber can be optimally adapted to the spatial situation of different installations already by applying the scintillator layer at the appropriate location of the light-conducting fiber.

As an alternative to applying the scintillator layer for example on a light-conducting fiber, it is also possible to equip the light-conducting fiber directly with fluorescent atoms. The ions implanted in a layer of the light-conducting fiber can in this case lead to scintillation, specifically to fluorescence.

As a means to achieve a suppression of spurious light which, due to the emission properties of the light source, is always present in EUV illumination systems, it may be envisioned to insert a filter material in the light path before the scintillator layer. It is for example possible to put a filter coating on the surface of the scintillator layer which receives the EUV light, for example a layer of zirconium with a thickness of e.g. 50 nm. The filter coating is distinguished by the property that it has a high transmissivity for EUV light of e.g. 95%, but that it reflects more than 90% of the fluorescent light of longer wavelengths which is produced by the scintillations. Besides achieving a suppression of spurious light, this concept provides in addition the possibility to significantly increase the efficiency of collecting the fluorescent light. Filter coatings have been disclosed for example in U.S. Pat. No. 7,154,666.

In a preferred embodiment of the invention, the detection element is configured as a photo detector. A photo detector can have the form of a photodiode, a photomultiplier, or a photo resistor. As a conceivable alternative, one could also use a thermo sensor instead of a photo detector.

The detection element of the device for the detection of radiation is preferably arranged outside of a vacuum chamber which encloses the optical elements of the illumination system.

The EUV light which is received by the conversion element in the vacuum chamber and which has been converted into fluorescent light is taken out of the vacuum chamber in which the optical elements are arranged and directed to the photo detector by way of the light conductor and a vacuum-tight passage, for example a vacuum window.

The detector device for EUV radiation according to the invention with a conversion element that converts the incident radiation with an operating wavelength λ_{operating} into a radiation with a longer wavelength λ_{fluorescent} is used preferably in an illumination system. The invention therefore also provides an illumination system for a microlithography projection exposure apparatus, in particular for wavelengths shorter than 100 nm, which is equipped with such a detector device.

In a preferred embodiment, the illumination system according to the invention further includes a device which receives the light intensity signal of the detector and produces a control signal which depends at least on the received light signal, wherein the control signal serves for example to set a scanning velocity of a light sensitive object in an image plane of the microlithography projection exposure apparatus. Either as an alternative or simultaneous to controlling the scanning velocity, it is possible to control the light source.

The detector according to the invention, which receives the light intensity signal, is also referred to as dosis sensor. Such a dosis sensor is arranged in the illumination system preferably at a location that is representative for the dose in the overall field which is being illuminated in the field plane. A possible embodiment of the invention includes for example a full-surface beam splitter which is arranged before the field plane in the light path from the light source to the object that is to be illuminated, and which directs a fractional amount of the light intensity of the entire field to a dosis sensor. However, an arrangement of this kind is hard to realize at the present time for wavelengths in the EUV range, because suitable beam splitters for these wavelengths are difficult to produce.

In a further embodiment of the invention it is therefore envisioned that the illuminated area in the field plane of the illumination system is larger than the area which is required in the image plane for the exposure of a light-sensitive object. Preferably, a light-sensitive object, for example a wafer, is arranged in the image plane of the projection objective. It is possible to arrange a dosis sensor in the unused area, i.e. in the part of the field which is not projected into the image plane. However, when arranging a detector according to the invention in this manner as a dosis sensor, it is disadvantageous that the structured object arranged in the field plane, also called reticle, is normally an exchangeable part that needs to be mechanically installed and uninstalled. A dosis sensor arranged in the field plane is difficult to reconcile with these mechanical requirements.

In another alternative embodiment of the invention, it is therefore envisioned that the dosis sensor is arranged in the illumination system and, more specifically, close to the field plane, in such a way that the mechanical components that serve to move the mask can be realized without a problem. On the other hand, the distance of the dosis sensor from the field plane should be such that the half-shadow of the sensor which is determined by the aperture angle of the illumination is kept as small as possible, so as to not overly restrict the usable field. With preference, the distance of the sensor is chosen so that the half shadow in the field plane which is determined by the aperture angle of the illumination is of such a size that the field area which is unusable because of the half shadows in the field plane is less than 40%, preferably less than 30%, and with the strongest preference less than 20% of the size of the sensor.

For example, if the sensor is round and has a diameter of 1 mm, and if the unusable field portion in the field plane is to be only 20% larger than the sensor itself, the diameter of the unusable field portion in the field plane is 1.2 mm. With an object-side aperture NA_{obj} of 0.0625 on a reticle that is arranged in the field plane, the sensor can have a distance of no more than 1.6 mm from the reticle plane in order to satisfy the requirement for the unusable field portion to be only 20% larger than the dosis sensor itself.

The linear dimension of the sensor is critical only in the direction perpendicular to the scanning direction, i.e. in the x-direction. The dimension in the y-direction, i.e. in the scanning direction, is irrelevant, as the scan is performed in this direction. Advantageously, the sensor dimensions are therefore often even bigger in the y-direction than the dimension of the field itself. In this case, position errors are in first approximation of no consequence. An oblong sensor of this kind is illustrated for example in FIG. 3b. A sensor that is elongated in the y-direction is advantageous because, in a special embodiment, it covers the entire field in the y-direction. A sensor which is elongated in this way in the y-direction is insensitive to mechanical instabilities and dislocations in the y-direction. The dimension of the sensor in the x-direction is preferably selected as small as possible, so that the area in the field plane which is illuminated but not used for the projection into the image plane can be chosen as small as possible.

In a further embodiment of the invention, it is envisioned that the dosis sensor is used for detecting the illumination in a pupil plane rather than for detecting the field illumination. The sensor has its maximum sensitivity in this case in regard to the setting of the pupil. For the detection of the illumination in the pupil plane, the sensor is preferably arranged in the pupil plane itself or in plane that is conjugate to the pupil plane; but in order to minimize the vignetting of the pupil as much as possible, the sensor should not be placed in the plane itself, but near the plane.

In a further embodiment of the invention, it is envisioned for the dosis sensor to be arranged in or near an intermediate focus of the light source.

If the sensor is arranged in an intermediate focus, for example after a first grazing-incidence collector, it is possible to obtain a signal which is independent of changes of the characteristics of the illumination system, for example independent of adjustments of the setting.

In any case, the sensor needs to be arranged so that the sensor is illuminated by the light source and that a representative signal is generated, but so that the projection light path from the field plane to the image plane, i.e. the image of the reticle that is projected into the image plane, is not negatively affected.

Besides the device for the detection of EUV radiation and the illumination system, the invention also proposes a method for the detection of EUV radiation as well as a method of setting an essentially constant light intensity for example in a field plane of a microlithography projection exposure apparatus. Under the method for setting an essentially constant light intensity for example in a field plane of a microlithography projection exposure apparatus, at least one detector according to the invention is arranged in or, as described above, in the proximity of the field plane. The light energy of the radiation being used to operate the lithography apparatus, for example EUV radiation in the range of wavelengths from 11 to 14 nm, is measured by means of the detector according to the invention, producing a current actual value. The measured actual value is then compared to a target value which is determined for example through a calibration measurement. To allow the calibration measurement to be performed, the design can for example provide for a calibration sensor to be arranged in the exposure apparatus. After the system has been turned off, the calibration sensor—for example through a mechanical swivel movement—is placed in the plane where the exposure object, for example the wafer, is arranged. For reasons of stability and reproducibility, the calibration sensor is in most cases designed as a calibrated photodiode.

After the target value has been compared to the actual value, a signal is generated which represents the difference between the target value and the actual value and provides the basis for a regulating unit to set for example a scanning velocity of a light-sensitive object in an image plane of the microlithography projection exposure apparatus and/or to regulate or control the light intensity of the light source in accordance with the signal. The light intensity of the light source can on the one hand be set by way of the pulse frequency of the light source or the amount of energy of the light pulses. In plasma discharge sources, the energy amount of the light pulses can be set for example through the discharge voltage or the discharge current or the charge quantity per pulse.

Besides the aforementioned possible solutions of regulating the light source through the pulse frequency, the plasma light sources used in EUV illumination systems further offer the possibility of influencing the pulse energy of the plasma light source by changing the gas pressure and the gas flow of the plasma light source as well as the composition of the gas. In regard to the composition of the gas, it would for example be possible to put additives such as for example tin into the plasma. The plasma could further be influenced in the ignition process by means of an ignition aid, a pre-ionization or an ignition laser.

As an alternative or additional measure, the illumination in the field plane could be controlled by an element that serves to influence the illumination in the field plane, for example by the signal of a sensor as disclosed in WO 2005/040927. Elements of this kind are also referred to as attenuators or as elements for controlling the uniformity of the field plane.

For example, if the device according to the invention is placed in a pupil plane, it is possible to influence the illumination of the pupil, for example by an attenuator element for the control of the pupil illumination as disclosed in WO 2006/06638.

The detector according to the invention can be used not only in the illumination system, but also in the area of the projection objective of a microlithography projection exposure apparatus. Possible locations where a detector according to the invention can be used in the projection system include for example an arrangement where the detector is installed as an intensity sensor in or near a pupil plane of the projection objective. It is also possible to arrange it in or near the image plane of the projection objective, or in or near a plane that is conjugate to the image plane, where the wafer is located. In the latter arrangement, the detector can be used as uniformity sensor or spot sensor.

In the following, the invention will be described through examples of embodiments as illustrated in the drawings, wherein

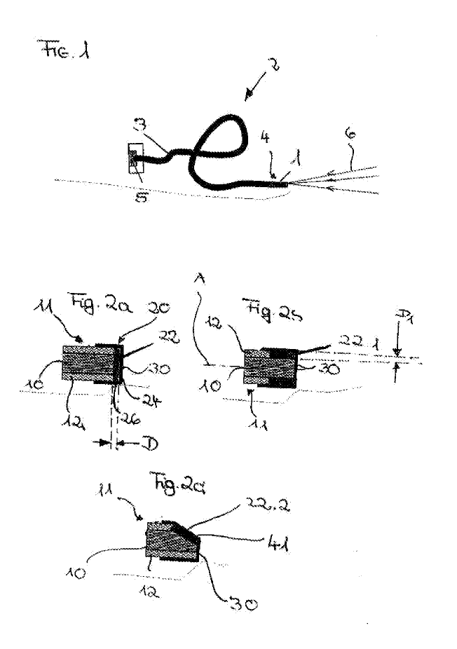

FIG. 1 schematically illustrates the design concept of a first embodiment of a device according to the invention;

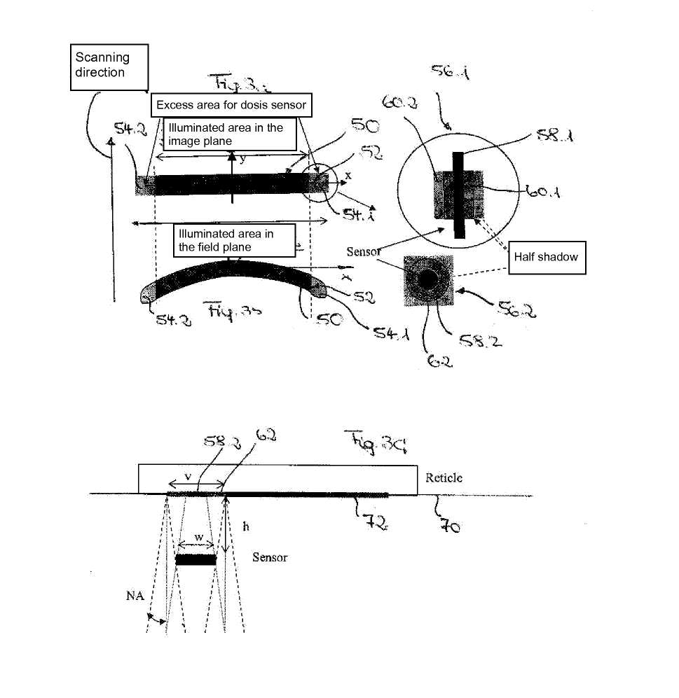

FIGS. 2a to 2c show possible embodiments of a device according to the invention with a scintillator layer;

FIGS. 3a to 3c illustrate a possible arrangement of the field in a field plane of the microlithography projection exposure apparatus as well as the definition of the distance of a sensor that is arranged close to the field;

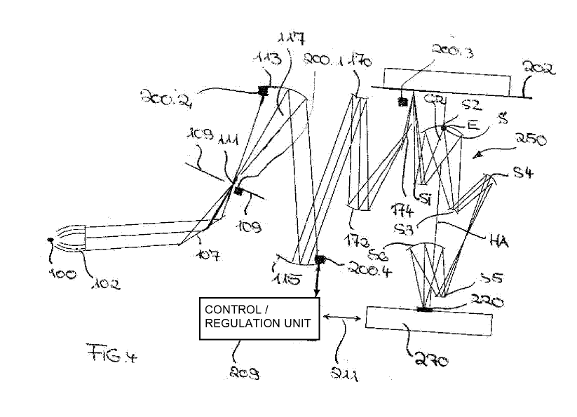

FIG. 4 shows an illumination system for EUV lithography with a sensor element according to the invention arranged in different positions;

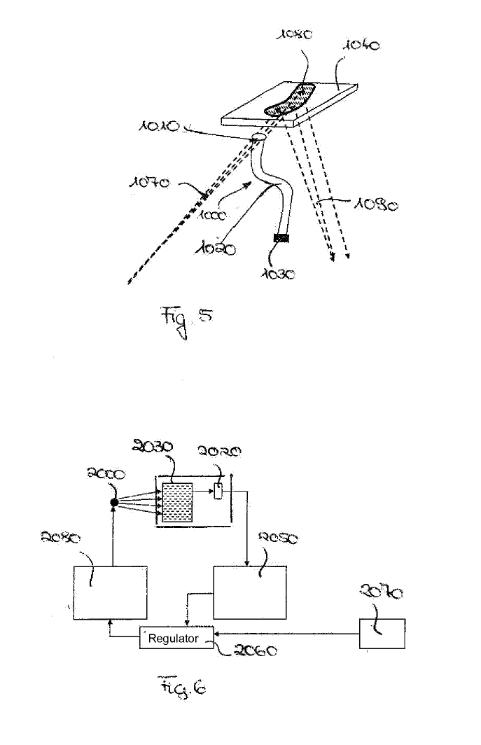

FIG. 5 shows a detail view of a sensor element according to the invention in the proximity of a field plane of the microlithography projection exposure apparatus; and

FIG. 6 illustrates a closed-loop regulating arrangement for the control of an EUV source with a sensor element according to the invention.

In FIG. 1 a possible configuration of a device according to the invention, i.e. a detector 2 according to the invention, is schematically illustrated. The arrangement according to the invention includes a conversion element 4 with a scintillator material 1 which is not shown in detail here. The radiation with a wavelength <100 nm, particularly in the range of EUV wavelengths, which falls on the conversion element is converted through interaction with the scintillator material 1 into radiation with a wavelength >100 nm, resulting in luminescent light, specifically fluorescent light. With the help of the light-conductor element which in this case is configured as a light conductor 3, for example a glass- or quartz fiber whose function is based on total reflection, the luminescent or, more specifically, fluorescent light is directed to a detection element, in this case a photodiode 5, and is registered by means of the photodiode 5.

FIGS. 2a to 2c illustrate possible configurations of the conversion element in the end portion of the light-conducting element, i.e. the light conductor 3. Where components in FIG. 2a to 2b are the same as in FIG. 1, the same reference symbols are used as in FIG. 1.

The light-conducting element as shown in FIG. 2a to 2c consists of a light-conducting fiber 11 with a core 10 as well as a circumferential surface layer 12, a so-called cladding. The light-conducting fiber 11, which is realized as a glass fiber, uses the principle of total reflection serves to direct the long-wave light, which has been converted by the action of the scintillator material in the conversion element and is also called luminescent or fluorescent light, to the photo detector. The conversion element 20 consists of a scintillator layer 22. The scintillator layer 22 has a first surface 24 and a second surface 26 as well as a thickness D. The thickness D of the scintillator layer is preferably <1 mm, more preferably <0.1 mm, with particular preference <0.01 mm, and with the highest preference 0.001 mm. Most preferred are thicknesses D between 1 μm and 100 μm, in particular between 10 μm and 50 μm. The penetration depth of light into the scintillator material of the scintillator layer is in fact only a few nanometers, so that layer thicknesses of less than 1 mm are sufficient.

In order to increase the yield from the luminescence, specifically fluorescence, and to prevent the entry of unwanted radiation with wavelengths different from the operating wavelength, it is intended to coat the first surface 24 of the scintillator layer 22 with a filter coating 30, for example a zirconium coating with a thickness of about 50 nm.

In the embodiment of FIG. 2a, the scintillator layer 22 is applied to the end surface 23 of the light-conducting fiber 11. In the embodiment according to FIG. 2b, the end surface of the light-conducting fiber 10 is protected by means of a filter 30, and the scintillator layer 22.1 is arranged in the area of the cladding 12 around the core 10 of the light-conducting fiber. If the light conductor 11 is rotationally symmetric about the axis A, the scintillator layer 22.1 is likewise rotationally symmetric about the same axis A and surrounds the core 10 of the light-conducting fiber. The thickness D₁ of the scintillator layer is in this case approximately equal to the thickness of the cladding 12. The scintillator layer can in such a case also be produced by doping the cladding in the specific area which is identified by the reference symbol 22.1.

In a further developed embodiment according to FIG. 2c, the glass fiber 11 is partially bias-cut at the end, and the scintillator layer 22.2 is arranged on the obliquely cut surface 41 of the core 10.

As illustrated in FIGS. 2a to 2c, the different arrangements of the scintillator layer on the light-conducting fiber allow the detector element to be optimally adapted to the given spatial situation of the design and the emission properties of the signal that is to be detected, but avoiding for example the need to bend the light-conducting fiber, which often causes the light-conducting fiber to break.

The filter coating preferably has a high transmissivity for radiation with wavelengths shorter than 100 nm, in particular EUV light. Preferably, the transmissivity for EUV light is 80%, in particular more than 95%, and the reflectivity for fluorescent light is over 60%, in particular more than 80%.

FIGS. 3a and 3b represent examples of illuminated fields in the field plane of a microlithography projection exposure apparatus. FIG. 3c shows how a half shadow is produced in the field plane as a consequence of arranging a sensor in the illumination light path, wherein the sensor is arranged close to the field plane.

The illuminated fields can for example have an arcuate shape (FIG. 3b) or a rectangular shape (FIG. 3a). In systems that operate with an operating wavelength in the range ≧193 nm, i.e. in systems of a refractive design, the illuminated fields are generally rectangular fields. In systems that work with operating wavelengths in the range ≦100 nm, particularly in the EUV range, the illuminated fields are generally arcuate fields.

A local Cartesian coordinate system is drawn into the field plane in FIG. 3a as well as in FIG. 3b. The y-axis indicates here the direction parallel to the scanning direction, and the x-axis indicates the direction perpendicular to the scanning direction and parallel to the field plane. The field in the field plane shown in FIGS. 3a and 3b is projected by the projection objective, generally in a reduced size according to the projection scale factor, for example with a fourfold, sixfold or eightfold reduction. The shape of the field remains largely preserved, meaning that the shape of the image field corresponds to the shape of the object field in the field plane, reduced by the scale factor of the projection. In a scanning microlithography projection exposure apparatus, since the illuminated field is moved in a scanning direction, the width in the direction of the illuminated field can be relatively narrow and is in the range of a few millimeters. In the direction perpendicular to the scanning direction, the dimension of the field is significantly larger and preferably corresponds to the width of the light-sensitive object in the image plane.

The area in the field plane which is needed for the illumination in the image plane of the projection objective is identified by the symbol 50. As can be concluded from FIGS. 3a and 3b, the illuminated area 52 in the field plane of the illumination system is larger than the area 50 which is required in the image plane. The illuminated area 52 in the field plane has excess portions 54.1 and 54.2. A sensor element according to the invention can be arranged in the area of the excess portions 54.1 and 54.2, as is shown for example in FIGS. 2a to 2c. The excess portion 54.1 with a sensor element arranged in the area of the excess portion is represented in the detail views 56.1 and 56.2. In the detail drawing 56.1, a sensor element 58.1 which is elongated in the scanning direction is shown with the half shadows 60.1 and 60.2 that are caused by the sensor element. In the detail drawing 56.2, a round sensor element 58.2 is shown with the half shadow 62 that is caused by the sensor element.

The half shadows 60.1, 60.2 and 62 are caused by arranging the sensor element in the illumination light path before the field plane. This is illustrated in FIG. 3c for a round sensor element 58.2.

In FIG. 3c:
h stands for the distance of the sensor element 68 from the field plane 70, measured perpendicular to the field plane 70 in which a structured mask 72, the so-called reticle, is arranged;
w stands for the dimension of the sensor element; and
v stands for the dimension of the area in the field plane which is not illuminated because of the arrangement of the sensor element, with the half-shadow 62.

If a maximum dimension is prescribed for the half-shadow that is not to exceed 20% of the dimension of the sensor element, and assuming a numerical aperture NA_{Obj}=0.0625 at the object, i.e. at the reticle, as is normal for EUV systems, further assuming a dimension w=1 mm for the sensor element, one obtains as a result a maximum width u=0.1 mm for the half-shadow.

Thus, the maximum distance h is

h=u/NA=0.1 mm/0.0625=1.6 mm

For the sensor element to be arranged close to the reticle means accordingly that the distance of the sensor element from the reticle plane is 1.6 mm or less.

FIG. 4 shows an example of an illumination system for an EUV projection exposure apparatus in which a detector according to the invention is being used.

The microlithography projection exposure apparatus in FIG. 4 includes a light source 100 which emits light of a specific wavelength. The light has a wavelength shorter than 100 nm, preferably in the EUV range, for example around 13.5 nm. The light emitted by the light source is collected by the collector 102 which is designed as a grazing-incidence collector according to the example shown in WO 2002/27400.

The radiation emitted by the light source is filtered by means of the spectral filter element 107 working together with the aperture stop 109, so that in essence only usable radiation, for example of 13.5 nm wavelength, is present behind the aperture stop 109. The spectral filter in the form of a grid element diffracts the light falling on it in different directions, for example in the direction of the first-order diffraction. The aperture stop 109 is arranged in or near the intermediate image 111 of the primary light source 100 in the first order of diffraction. An embodiment of the invention can be designed with a detector 200.1 according to the invention, as illustrated in FIGS. 2a to 2c, arranged near the intermediate focus 111 of the light source, at a location which lies before the aperture stop 109 in the light path from the light source 100 to the field plane 202. Placed in this position, the detector 200.1 can detect a light signal of the light source 100 if the intermediate image 111 of the light source 100 is larger than the opening width of the aperture stop 109. In such a position, a light intensity signal can be detected which is not influenced by the optical components lying downstream in the illumination system. It is preferred to arrange four or more detectors before the aperture stop 109. For example with a quadrant detection as disclosed in WO 2004/031854, it is possible to measure not only the light intensity but to obtain asymmetry signals and symmetry signals from the measured intensities of the respective quadrant detectors, whereby it becomes additionally possible to detect an out-of-adjustment condition of the light source 100 relative to the part of the illumination system which lies in the light path behind the aperture stop 109. The disclosure content concerning the quadrant detection as described in WO 2004/031854 is hereby incorporated by reference in its entirety in the present application.

The illumination system 112 of the microlithography projection exposure apparatus further includes in the light path after the intermediate focus 111 a first facetted optical element 113 with first facets, so-called field raster elements, which in catoptric systems are configured as small facet mirrors, and a second optical element 115 with second facets, so-called pupil raster elements or pupil facets, which in catoptric systems are likewise configured as facet mirrors. The first optical element 113 which comprises the field facets splits the light bundle 117 arriving from the primary light source 100 into a multitude of light bundles. Each of the light bundles is being focused and forms a secondary light source at or near the location where the second facetted optical element 115 with pupil raster elements is arranged.

As a further possibility at least one detector 202.2 could be arranged on the field facet mirror 113. Such a detector would be arranged in the far field of the so-called source/collector unit which consists of the light source 100 and the collector 102. The detector according to the invention is a detector of the kind illustrated in one of FIGS. 2a to 2c. There can be a single detector or a plurality of detectors arranged on the field facet mirror 113. The one or more detectors 202.2 are arranged adjacent to the individual field facets on the field facet mirror 113 which has a large number of field facets, for example in gaps between two neighboring field facets on a carrier element for the individual field facets. In a EUV illumination system, the field facets are designed as reflective elements in the nature of a field facet mirror. With detectors 202.2 which are arranged on the field facet mirror, it is possible to measure fluctuations of the source intensity. An arrangement of detectors on a field facet mirror adjacent to individual filed facets on the carrier element is shown in WO 2004/031854. The content of WO 2004/031854 is in this regard incorporated by reference in its entirety in the disclosure content of the present application.

In order to detect the change of the light intensity in the field plane—and thus also the change in the image plane where the object to be illuminated is arranged—which change is caused for example by fluctuations of the light source or by inserting an aperture stop for the adjustment of the illumination, it can be envisioned in a further embodiment of the invention that at least one detector according to the invention as illustrated in FIGS. 2a to 2c is arranged in or near a field plane or a conjugated field plane.

The detector 200.3 shown in FIG. 4 is located near a field plane 202 of the illumination system where a structured mask, the so-called reticle is arranged. Arranging the detector in the field plane 202 is not possible in a normal case, because the reticle needs to be designed for mechanical exchangeability. When arranging the detector near the field plane 202, care must be taken that the half shadow which is determined by the aperture angle of the illumination causes only the smallest possible amount of vignetting in the illuminated area of the field plane. In this regard, the reader is referred to the description of FIG. 3c.

It would also be possible (but is not shown in the drawing) for a device according to the invention to be arranged in the projection objective, for example as an intensity sensor in or near a pupil Plane of the projection objective. One could also consider arranging the device in or near the image plane of the projection objective, i.e. in or near the plane in which the wafer is located. There, the detector can be used as uniformity sensor or as spot sensor.

The arrangements discussed above are intended only as examples.

The detector according to the invention can also be placed in any other locations of the illumination system in the light path from the light source to the field plane. It is also possible to use a plurality of detectors (not shown) which are arranged in different places. As an alternative possibility the detector 200.1, 200.2, 200.3 can also be designed to be movable between different positions. Of course, the detectors 200.1, 200.2, 200.3 are meant to serve only as examples; it would also be possible to arrange not just one but a multitude of such detectors in each of the positions indicated in the drawing, as has already been mentioned.

As a further possibility, the detector could also be arranged in a pupil plane of the illumination system. A pupil plane of the illumination system is a plane in which the exit pupil of the illumination system is located, or a plane that is conjugate to the exit pupil. For example, the second facetted optical element, the so-called pupil facet mirror, is arranged in a pupil plane. A detector 200.4 according to the invention could therefore be arranged on the pupil facet mirror 115. The detector 200.4 arranged on the pupil facet mirror or, if applicable, the plurality of detectors arranged on the pupil facet mirror, are normally illuminated with light which is received by one or more field facets of the field facet mirror 113 and is directed to the detector 200.4. By means of the field facet of the field facet mirror 113, this light is uncoupled from the illumination ray pattern that contributes to the illumination of the field plane, so that the uncoupled light will therefore not contribute to the illumination of the field. With the help of this kind of detector which is arranged on the carrier element of the pupil facet mirror, it is possible to not only determine a fluctuation of the light intensity of the light source 100, but also to determine the positioning of the source/collector module consisting of light source 100 and collector 102 relative to the illumination system that follows downstream, as described in WO 2004/031854, the disclosure content of which is hereby incorporated by reference in its entirety in the present application.

The light signal received by the detector 200.1, 200.2, 200.3, 200.4 can be used directly as a control signal or regulating signal for a control/regulation unit 209, for example to set the scanning velocity, e.g. through the signal line 211, and/or to the set the light intensity of the light source. Using the signal of the detector according to the invention, it is possible to regulate or compensate for example intensity fluctuations of the light source.

In the present example of an embodiment of a microlithography exposure apparatus there are in addition two normal-incidence mirrors 170, 172 and one grazing-incidence mirror 174 shown in the light path behind the second facetted optical element, i.e. the pupil facet mirror, wherein the mirrors 170, 172, 174 serve to form an image of the pupil facets in the entry pupil E of the projection objective for the purpose of shaping the field in the object plane. If the field raster elements have the shape of the field that is to be illuminated, it is not necessary to provide a mirror for the shaping of the field.

The entry pupil E of the projection objective, which coincides with the exit pupil of the illumination system is determined by the point where the optical axis HA of the projection objective 250 intersects the principal ray CR (after reflection of the latter at the reticle) to the central field point Z of the field shown in FIG. 3.

A reticle is arranged on a transport system in the object plane 202 of the microlithography projection exposure apparatus. An image of the reticle which is arranged in the object plane 202 is projected by means of the projection objective 250 onto a light-sensitive substrate 220, for example a wafer. The wafer or substrate is arranged essentially in the image plane of the projection objective 250. The uniform exposure of the light-sensitive substrate is controlled by the regulation unit 209 which sets the scanning velocity of the carrier system 270 on which the light-sensitive substrate is arranged, or regulates the pulse frequency of the light source dependent on the light signal received by the detector 200.1, 200.2, 200.3, 200.4.

In the illustrated example, the projection objective has six mirrors, i.e. a first mirror S1, a second mirror S2, a third mirror S3, a fourth mirror S4, a fifth mirror S5, and a sixth mirror S6 set up in a centered arrangement about a common optical axis HA. The illustrated projection objective 250 has a positive back focus. This means that the principal ray CR to the central field point, which is reflected by the reticle, enters the projection objective in a direction towards the reticle. Projection objectives with negative back focus are also possible, as disclosed for example in WO 2004/010224. The point S where the optical axis HA of the objective intersects the principal ray CR to the central field point after reflection of the latter at the reticle determines the position of the entry pupil E which coincides with the exit pupil of the illumination system. By means of an aperture stop (not shown), or with a variable assignment of field facets to pupil facets, it is possible to change the illumination in the pupil plane or entry pupil, i.e. to adjust the setting at that location.

In all aspects, the EUV projection exposure apparatus illustrated in FIG. 4 is to be taken only as an example which implies no limitation of the invention.

The detectors according to the invention can be used in microlithography projection exposure apparatus of any design configuration, in particular for wavelengths shorter than 100 nm. As a common trait, all microlithography projection exposure apparatus have an illumination system serving to illuminate a field and to form an angular distribution in an exit pupil, as well as a projection system serving to project an image of an object in an object plane into an image plane.

FIG. 5 represents again a detail view of a possible arrangement of a detector 1000 according to the invention in or near a field plane. A detector in such a position is also shown in FIG. 4, identified with the symbol 200.3. The detector 1000 includes a conversion element 1010, a light-conducting element 1020 as well as a detection element 1030. One can further see the field plane 1040 of the projection exposure apparatus as well as the field 1080 which is illuminated by the EUV radiation 1070 falling on it from the light source. The field plane 1040 is likewise shown in FIG. 4 where it is identified by the symbol 202. The illuminated field 1080 has a shape as shown in FIG. 3. The light of the light source (not illustrated here) is directed through the illumination system which can be designed in the way shown in FIG. 4. The incident EUV ray path from the light source is identified as 1070. The incident illuminating radiation 1070 is reflected in the field plane 1080, for example on a reticle 1090 (not shown) which is of a reflective type, and enters as an image-projecting ray path 1090 into the projection objective which projects an image of the structure of the reticle onto a light-sensitive coating.

The scintillator head 1010 which serves to receive the light signal is arranged in the ray path 1070, as illustrated for example in FIG. 3c. The half-shadow which the detector in this arrangement produces is shown in FIG. 3c.

The placement of the detector close to the field plane is governed by the size of the half shadow, as in the example described in the context of FIG. 3c.

FIG. 6 again schematically represents the regulation loop which serves to ensure a uniform illumination in the field plane. The light emitted by the light source 2000 is measured by means of the detector device 2020. As a detection device, a photodiode 2030 is being used. When a photodiode is used, it is possible to generate by means of a converter 2050 a signal representing a current actual condition, for example a voltage signal, which is directed to a regulating unit 2060. The regulation unit compares the actual voltage signal to a set-point or target signal 2070 and based on the comparison regulates in the illustrated example the light intensity of the light source, for example by changing the pulse frequency of the light source.

The present invention is thus first in disclosing a device that is capable of detecting EUV radiation, wherein the detection element has a very long operating life. The device according to the invention further has the advantages of being mechanically and thermally robust and largely maintenance-free. In addition, the geometry of the devices can easily be adapted to the areas of detection. Expensive mountings are not required.

1. Device for detecting radiation with a wavelength λ<100 nm, preferably EUV radiation in a range of wavelengths of 5 nm<λ_{EUV}<30 nm in a microlithography projection exposure apparatus, comprising:
a conversion element (4) which comprises a scintillator material (22, 22.1, 22.2) which converts radiation with wavelengths of λ<100 nm falling on the conversion element, through interaction with the radiation with wavelengths of λ<100 nm, into a radiation with a wavelength λ_{fluorescent}>100 nm,
a detector element (5) serving to detect the radiation with a wavelength λ_{fluorescent}>100 nm received by the light-conducting element.

2. Device according to claim 1, characterized in that the device further comprises a light conducting element (3) which receives the radiation with a wavelength λ_{fluorescent}>100 nm.

3. Device according to claim 1 or 2, characterized in that the scintillator material is an inorganic material selected among the following:
quartz glass doped with cerium or other fluorescent atoms,
YAG- or YAP crystals doped with cerium,
calcium fluoride doped with europium,
barium fluoride doped with europium,
zinc selenide doped with tellurium,
CdWO₄ (cadmium tungsten oxide), and
Cesium Iodide doped with thallium.

4. Device according to one of the claims 2 to 3, characterized in that the light-conducting element (3) comprises a light-conducting fiber (11), in particular a glass- or quartz fiber, with a core (10) and a cladding (12), wherein the core (10) has a larger refractive index than the cladding (12).

5. Device according to claim 4, characterized in that the scintillator material (22.1) is arranged in the area of the cladding (12) of the light-conducting fiber (11) or constitutes a part of the cladding (12) itself.

6. Device according to one of the claims 2 to 4, characterized in that the light-conducting element is a light-conducting fiber (11) with an end surface (23) and wherein the scintillator material (22) is arranged on the end surface (23)

7. Device according to one of the claims 2 to 4, characterized in that the light-conducting element is a light-conducting fiber (11), wherein said light-conducting fiber comprises an obliquely cut end surface (41) and the scintillator material is arranged in the area of said obliquely cut end surface (41).

8. Device according to one of the claims 1 to 7, characterized in that the light-conducting element comprises a reflector.

9. Device according to claim 8, characterized in that the reflector comprises a metallic material.

10. Device according to one of the claims 1 to 9, characterized in that the detector element comprises a photo detector or a thermal sensor.

11. Device according to claim 10, characterized in that the photo detector is a photodiode, a photomultiplier, or a photo resistor.

12. Device according to one of the claims 1 to 11, characterized in that the conversion element comprises as a scintillator material a scintillator layer with a layer thickness D₁ and wherein radiation with wavelengths <100 nm falls on the scintillator layer.

13. Device according to claim 12, wherein the layer thickness is D₁<1 mm, preferably <0.1 mm, more preferably <0.01 mm, and with special preference <0.001 mm.

14. Device according to one of the claims 12 or 13; wherein the conversion element comprises a filter coating (30), and wherein said filter coating is put on top of the scintillator layer.

15. Device according to claim 14, wherein the filter coating has a high transmissivity for radiation with a wavelength λ<100 nm, i.e. higher than 80% and preferably higher than 95%, and at the same time has a high reflectivity for radiation with a wavelength λ>100 nm, i.e. higher than 60% and preferably higher than 80%.

16. Device according to one of the claims 14 to 15, wherein the filter coating comprises zirconium.

17. Illumination system for a microlithography projection exposure apparatus, wherein the illumination system comprises a light source which emits light with a wavelength λ, and a detector which receives the light of the light source with the wavelength λ, wherein the detector comprises a conversion element (4) with a scintillator material (22) which converts radiation with the wavelength λ falling on the conversion element into radiation with a wavelength λ_{fluorescent}>λ.

18. Illumination system according to claim 17, characterized in that the wavelength λ is in the range from 5 nm to 200 nm, preferably in the range from 5 nm to 30 nm.

19. Illumination system for a microlithography projection exposure apparatus, in particular for wavelengths <100 nm and preferably in the range of EUV wavelengths, wherein the illumination system comprises a light source serving to illuminate a field plane and further comprises at least one detector serving to detect light of the light source, wherein the detector is arranged in a light path from the light source to the field plane and is a device according to one of the claims 1 to 16.

20. Illumination system according to one of the claims 17 to 19, characterized in that the detector is arranged in or near a field plane.

21. Illumination system according to one of the claims 17 to 20, characterized in that the detector (200.1) is arranged in or near an intermediate focus in the illumination system.

22. Illumination system according to one of the claims 17 to 21, characterized in that the detector (200.4) is arranged in or near a pupil plane.

23. Illumination system according to one of the claims 17 to 22, characterized in that the detector is arranged in or near a field plane.

24. Illumination system according to one of the claims 17 to 23, characterized in that the radiation that falls on the detector is uncoupled by means of a mirror.

25. Illumination system according to claim 24, characterized in that the mirror is a grazing-incidence mirror.

26. Illumination system according to claim 24, characterized in that the mirror is a multi-layered mirror.

27. Illumination system according to one of the claims 17 to 26, characterized in that the detector is arranged so that the light falls directly on the scintillator material.

28. Illumination system according to one of the claims 17 to 27, characterized in that the illumination system comprises a device which receives at least one light intensity signal of the detector and, dependent on at least the received light intensity signal, provides a control signal through which a scanning velocity of a light-sensitive object in an image plane of a microlithography projection exposure apparatus or the light intensity of the light source can be adjusted.

29. Illumination system according to one of the claims 17 to 28, characterized in that the device comprises a regulating unit with a memory storage unit in which at least one first calibration value is stored for an illumination of an area in a field plane.

30. Illumination system according to one of the claims 17 to 29, characterized in that a multitude of calibration values forming a calibration table are stored in the memory storage unit.

31. Microlithography projection exposure apparatus, comprising an illumination system according to one of the claims 17 to 30 serving to illuminate an object plane, and also comprising a projection objective serving to project an image of an object arranged in an illuminated area of the object plane into an image plane.

32. Microlithography projection exposure apparatus according to claim 31, characterized in that the projection objective comprises a device according to one of the claims 1 to 16.

33. Microlithography projection exposure apparatus according to claim 32, characterized in that the device is arranged in or near a pupil plane of the projection objective.

34. Microlithography projection exposure apparatus according to one of the claims 32 to 33, characterized in that the device is arranged in or near the image plane or in or near a plane that is conjugate to the image plane.

35. Method of detecting radiation with wavelengths shorter than 100 nm, in particular EUV radiation in a range of wavelengths of 5 nm<λ_{EUV}<30 nm in an illumination system, wherein the device comprises a conversion element which includes a scintillator material, and further comprises a detection element, said method comprising the following steps:
the EUV radiation falling on the conversion element is converted through interaction with the scintillation material into radiation with a wavelength longer than 100 nm,
the radiation with a wavelength longer than 100 nm is directed to the detection element,
the detection element detects a light intensity of the radiation with a wavelength longer than 100 nm.

36. Method of detecting according to claim 35, wherein the device comprises a light-conducting element and the radiation is directed by means of the light-conducting element to the detection element.

37. Method according to claim 35 or 36, wherein the scintillation material represents a scintillation layer with a layer thickness, and wherein the layer thickness is smaller than 1 μm and the radiation with a wavelength larger than 100 nm is produced through absorption of the incident EUV radiation in the scintillator material over a surface area.

38. Method according to one of the claims 35 to 37, characterized in that the light-conducting element is a light-conducting fiber and the light is being directed to the detector element by total reflection inside the light conductor.

39. Method of setting an essentially invariable light intensity in a field plane of a microlithography projection exposure apparatus for radiation with wavelengths <100 nm, in particular EUV radiation in a range of wavelengths of 5 nm<λ_{EUV}<30 nm, wherein the microlithography projection exposure apparatus comprises at least one detector according to one of the claims 1 to 16 arranged in the light path from a light source to a field, said method comprising the following steps:
a light energy is measured by means of a detector that is arranged in or in the proximity of the field plane, whereby a current actual value is obtained,
the light energy is compared to a target value,
a difference signal is established between the target value and the current actual value and, based on the difference signal, a scanning velocity of a light sensitive object in an image plane and/or a light intensity of a light source is adjusted.

40. Method according to claim 39, characterized in that a pulse frequency of the light source is adjusted.

41. Method according to one of the claims 39 or 40, characterized in that an energy quantity of a light pulse of the light source is adjusted.
